(19) United States
(12) Patent Application Publication
(10) Pub. No.: US 2006/0270046 A1
(43) Pub. Date: Nov. 30, 2006

(54) Processes for determining coke content based on catalyst color

(76) Inventors: Nicolas P. Coute, Houston, TX (US); Mark M. Disko, Glen Gardner, NJ (US); William C. Horn, Long Valley, NJ (US); William A. Lamberti, Stewartsville, NJ (US); Kun Wang, Bridgewater, NJ (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/140,187

(22) Filed: May 27, 2005

(51) Int. Cl. G01N 31/10

(52) U.S. Cl. 436/37; 436/139

(57) ABSTRACT

The invention provides processes for preparing and using an analytical tool for determining coke content on a catalyst composition. The analytical tool is particularly desirable in that it allows the determination of an average coke on catalyst level as well as a distribution of coke on catalyst levels of an unknown catalyst sample. The processes correlate color information with coke content, and provide an easy way to determine the amount of coke on the catalyst based on the color of the catalyst.

### FIELD OF THE INVENTION

The present invention relates to processes for determining the level of coke on catalyst compositions. More particularly, the invention relates to processes for determining the level of coke on catalyst compositions based on the color of the catalyst composition.

### BACKGROUND OF THE INVENTION

Light olefins, defined herein as ethylene and propylene, serve as feeds for the production of numerous chemicals. Olefins traditionally are produced by petroleum cracking. Because of the limited supply and/or the high cost of petroleum sources, the cost of producing olefins from petroleum sources has increased steadily.

Oxygenates such as alcohols, particularly methanol, dimethyl ether, and ethanol, are alternative feedstocks for the production of light olefins. In an oxygenate to olefin (OTO) reaction system, an oxygenate in an oxygenate-containing feedstock contacts a molecular sieve catalyst, preferably in a fast-fluidized reaction system, under conditions effective to convert at least a portion of the oxygenate to light olefins, which are yielded from the reaction system in a reaction effluent.

The OTO conversion process in a hydrocarbon conversion apparatus, particularly the conversion of methanol to olefins (MTO), generates and deposits carbonaceous material (coke) on the molecular sieve catalysts used to catalyze the conversion process. Excessive accumulation of these carbonaceous deposits will interfere with the catalyst's ability to promote the reaction. In order to avoid unwanted build-up of coke on molecular sieve catalysts, the OTO and MTO processes incorporate a second step comprising catalyst regeneration. During regeneration, the coke is at least partially removed from the catalyst by combustion with oxygen, which restores the catalytic activity of the catalyst and forms a regenerated catalyst. The regenerated catalyst then may be reused to catalyze the conversion of methanol to olefins.

In conventional reaction systems, a portion of the catalyst population in a reactor is removed therefrom and directed to a catalyst regenerator. In the catalyst regenerator, a regeneration medium, usually comprising oxygen, enters the regenerator, and coke is removed from the coked catalyst by combustion with the regeneration medium to form regenerated catalyst and gaseous byproducts. The bulk of the regenerated catalyst from the regenerator is returned to the reactor. The gaseous byproducts are forced out an exhaust outlet oriented in the upper section of the catalyst regenerator.

In OTO reaction systems, the amount of coke on the catalyst directly impacts the composition of the products formed in the OTO reaction effluent. For example, increasing coke loading of catalyst particles in MTO reaction systems, at least to a certain extent, can increase the amount of light olefins produced in an MTO reaction process. See, e.g., A. N. R. Bos, P. J. J. Tromp, and H. N. Akse, “Conversion of Methanol to Lower Olefins. Kinetic Modeling, Reactor Simulation, and Selection,” 34 Ind. Eng. Chem. Res. 3808 (1995); D. Chen, K. Moljord, T. Fuglerud, and A. Holmem, “The Effect of Crystal Size of SAPO-34 on the Selectivity and Deactivation of the MTO Reaction,” 29 Micro. and Meso. Materials 191 (1999), the entireties of which are incorporated herein by reference.

Although a certain amount of coke on catalyst may be desirable, coke levels that are too high may result in catalyst deactivation and undesirably low conversion. Conventionally, coke on catalyst levels have been determined by combusting coke from a catalyst sample and measuring the amount of combustion byproducts that are produced in the combusting step. Such processes are inconvenient in that each analysis requires combusting a catalyst sample and typically requires at least 0.25 to 0.5 grams of a catalyst sample.

Thus, the need exists for improved processes for determining the level of coke on catalyst in a reaction system in order to maximize conversion and selectivity to desired products. Such processes would be useful not only for determining whether a given population of catalyst particles has a desirable coke on catalyst level, but also in helping to determine the rate at which catalyst should be removed from a reactor and directed to a catalyst regenerator for regeneration.

### SUMMARY OF THE INVENTION

In one embodiment, the present invention provides a process for preparing an analytical tool for determining coke content on a catalyst composition. The process comprises preparing a plurality of first catalyst samples, each first catalyst sample having a known coke content. A first color information for each of the plurality of first catalyst samples is determined, and a color correlation is determined that establishes a quantitative relationship between the first color information and the known coke content for the plurality of first catalyst samples. Preferably, the process further comprises determining the known coke content for each first catalyst sample by combusting coke on a portion of each first catalyst sample in the presence of oxygen and measuring an amount of combustion products yielded by the combusting.

In a preferred embodiment, the invention includes a step of obtaining a digital image for each of the plurality of first catalyst samples. The image may contain color data such as actual color names or color characteristics. For example, red-green-blue or hue-saturation-luminance.

In another embodiment, the process comprises determining second color information for a second catalyst sample, wherein the second catalyst sample has an unknown coke content. The second color information is applied to the color correlation to determine one or more values for the unknown coke content.

In yet another embodiment, the process comprises determining the known coke content for each first catalyst sample. This determination can be done by combusting coke on a portion of each first catalyst sample in the presence of oxygen and measuring an amount of combustion products yielded by the combusting.

The invention is also directed to a process for analytically determining coke content of a catalyst sample. In one embodiment, a color correlation that correlates coke content as a function of color information is provided. Color information for the catalyst sample is determined, wherein the catalyst sample has an unknown coke content, and the color information is applied to the color correlation to determine one or more values for the unknown coke content.

In another embodiment, the invention is directed to a process for monitoring coke-on-catalyst content in an oxygenate to olefin reaction system. The process includes contacting an oxygenate-containing feedstock with a catalyst composition in a reaction zone under conditions effective to convert at least a portion of the oxygenate-containing feedstock to light olefins. A first portion of catalyst particles is withdrawn from the reaction zone, and a color correlation that correlates coke content as a function of color information is provided. Color information of the first portion, wherein the first portion has an unknown coke content, is determined, and the color information is applied to the color correlation to determine one or more values for the unknown coke content.

In another embodiment, the process further comprises obtaining a luminance value for each pixel in the digital image. The digital image can be a gray scale digital image, and each luminance value can be an 8 bit value. Such value can range from 0 to 255. Additionally or alternatively, each luminance value can be based on one or more of red color information, green color information, blue color information or a combination of red, green and/or blue color information. Additionally or alternatively, the process further includes segmenting the images to isolated individual catalyst particles for image analysis. Additionally or alternatively, the process comprises preparing a histogram sorting pixels of the digital image by luminance value.

Catalyst samples taken or used according to the invention comprise a plurality of catalyst particles. In one embodiment, the catalyst particles are spheroid catalyst particles. In a preferred embodiment, the color information optionally comprises central color information based on central regions of the catalyst particles, particularly catalyst particles that are spheroid.

In a preferred embodiment the catalyst is a molecular sieve catalyst. Preferably the molecular sieve catalyst is selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

In another embodiment, the average coke content on the catalyst and/or the coke level distribution on the catalyst as determined by measurement of the color of the coke is used to control one or more process variables to control and/or optimize a hydrocarbon conversion process, preferably an oxygenate-to-olefins process. Any one or more of the above aspects of the invention can be used alone or in combination to improve, optimize and/or stabilize process operation by optimizing regeneration conditions, catalyst addition and withdrawal rates and/or catalyst selectivity, avoiding thermal upsets, and/or stabilizing other aspects of the process operation.

### BRIEF DESCRIPTION OF THE DRAWINGS

The present invention will be better understood with reference to the attached figures, wherein:

FIG. 1 is a histogram based on color information of a relatively homogenous first catalyst sample having a relatively uniform coke on catalyst level;

FIG. 2 is an image of a plurality of catalyst particles having a wide coke level distribution;

FIG. 3 presents a flow diagram illustrating an oxygenate to olefin reaction unit and an effluent processing system;

FIG. 4 presents a graph plotting luminosity against coke levels for SAPO-34 catalyst particles; and

FIG. 5 illustrates a coke distribution measured with the novel technique according to the present invention.

### DETAILED DESCRIPTION OF THE INVENTION

### A. Introduction

The present invention is directed to processes for preparing an analytical tool for determining the amount of carbonaceous deposits, e.g., coke, on a specific population of catalyst particles. The invention is also directed to processes for utilizing the analytical tool to determine the amount of carbonaceous deposits on a sample of catalyst particle having an unknown coke on catalyst content. By providing the ability to determine the level of coke on a population of catalyst particles, the present invention provides the ability to quickly and accurately evaluate how the catalysts would perform in a reaction system.

### B. Processes for Preparing an Analytical Tool

### for Determining Coke Content on Catalysts

It has now been discovered that coke deposited on molecular sieve catalyst particles exhibits a characteristic color, which changes as the coke level increases. As a result, known coke level/color correlations can be used to determine the amount of coke on an unknown catalyst sample based on the color of the catalyst particles in the unknown catalyst sample. The correlation between color and coke on catalyst levels is particularly pronounced with catalyst particles that are implemented in OTO reaction systems.

The analytical tool is particularly desirable in that it allows the determination of an average coke on catalyst level as well as a distribution of coke on catalyst levels of an unknown catalyst sample. For purposes of the present specification and the appended claims, “unknown catalyst sample” means a catalyst sample comprising one or more catalyst particles that have been exposed to a feed to produce an unknown amount of carbonaceous deposits, i.e., coke, on the catalyst particles. One purpose of the present invention is to provide an analytical tool for determining the amount of coke on an unknown catalyst sample based on the color information derived from the unknown catalyst sample.

For purposes of this specification, “coke content” and “coke on catalyst level” as used herein refer to the weight percentage of carbonaceous deposits (coke) contained on a catalyst composition, based on the total weight of the catalyst composition including the weight of the carbonaceous deposits thereon. “Coke distribution” is the distribution of coke on a population of catalyst particles. The coke distribution optionally is expressed in graphical form (e.g., as a histogram plotting the number of catalyst particles having various coke on catalyst levels), by a median coke content, or in terms of one or more cₓ values. The median coke content is the c₅₀ value for a specified plurality of particles. A cₓ value for purposes of this patent specification and appended claims means that x percent by weight of a specified plurality of particles (including the weight of coke thereon) have a coke content no greater than the cₓ value. For the purposes of this definition, coke content used to define the cₓ value is measured using the inventive processes of the present invention.

The size of catalyst particles may vary widely. In one embodiment, the catalyst particles have a median particle diameter ranging from about 5 to about 500 μm, preferably from about 10 to about 300, and most preferably from about 20 to about 200. As used herein, a “median particle diameter” means the d₅₀ value for a specified plurality of particles. A dₓ particle size for purposes of this patent application and appended claims means that x percent, by volume, of a specified plurality of particles have a particle diameter no greater than the dₓ value. For the purposes of this definition, the particle size distribution (PSD) used to define the dₓ value is measured using well known laser scattering techniques using a Microtrac Model S3000 particle size analyzer from Microtrac, Inc. (Largo, Fla). “Particle diameter” as used herein means the diameter of a specified spherical particle or the equivalent diameter of non-spherical particles as measured by laser scattering using a Microtrac Model S3000 particles size analyzer.

Each of the first catalyst samples ideally, but not necessarily, is homogenous. By “homogenous” it is meant that a specific population of catalyst particles, e.g., one of the first catalyst samples, comprises catalyst particles that have been exposed to a feed, preferably a methanol-containing feed, under reaction conditions for approximately the same period of time. As a result, the catalyst particles contained in the specific population of catalyst particles preferably have approximately the same coke on catalyst levels. In one embodiment, at least one of the first catalyst samples comprises virgin catalyst particles, defined herein as catalyst particles that have not been exposed to feed.

At least some of the first catalyst samples are exposed to the feed to form coke thereon. Each first catalyst sample preferably is exposed to the feed for a different period of time than the other first catalyst samples. As a result, each of the plurality of first catalyst samples preferably has different coke on catalyst levels than the other first catalyst samples.

Except for the periods of exposure, the specific reaction conditions under which each of the first catalyst samples is exposed to the feed preferably are about the same as the reaction conditions under which the unknown catalyst sample has been exposed to feed. Preferably, the reaction conditions under which the first catalyst samples are exposed to the feed vary from the reaction conditions implemented in the unknown catalyst sample by no more than 20 percent, more preferably no more than about 10 percent, and most preferably no more than about 5 percent.

In another preferred embodiment, the process includes determining the known coke content for each first catalyst sample. This can be done by combusting coke on a portion of each first catalyst sample in the presence of a combustion medium, e.g., oxygen, and then measuring an amount of combustion products yielded by the combusting.

The known coke content for each first catalyst sample preferably is achieved by contacting each respective first catalyst sample with a combustion medium, preferably comprising oxygen, in a combustion zone to combust a weight majority of the coke off of the catalyst particles. One commercially available process for determining coke on catalyst levels is total or flash combustion. A coked catalyst sample is measured with a high precision balance. The sample is entirely combusted in air or an O₂ enriched air mixture in the presence of combustion accelerators (e.g., copper and iron chips) at high temperatures. A LECO® CS200 is a commercially available instrument that can be used for carbon measurement.

In one embodiment, the combustion medium comprises at least about 50 weight percent oxygen, more preferably at least about 80 weight percent oxygen, and most preferably at least about 90 weight percent oxygen, based on the total weight of the combustion medium. Optionally, the combustion medium comprises air. The combusting conditions preferably include contacting the catalyst particles with the combustion medium at a temperature of from about 400° C. to about 1500° C., more preferably from about 500° C. to about 1250° C., and most preferably from about 800° C. to about 1200° C. The combusting optionally occurs in a fixed bed or fluidized bed combustion vessel. The amount of combustion medium introduced into the combustion zone optionally ranges from about 0.2 g to about 0.3 g, and most preferably from about 0.24 to about 0.26.

In the combusting step, the coke is converted to combustion products. The amount of combustion products formed in the combusting step then is measured to determine the relative amount of coke that was on the catalyst particles. The measuring of the amount of combustion products yielded by the combusting step is achieved through gas chromatography. Coke levels many also be accurately measured by other classic methods known to those skilled in the art, such as Thermo-Gravimetric-Analysis (TGA), Temperature Programmed Oxidation (TPO), Tapered Element Oscillating Micro Balance (TEOM), or Electron Microprobe Analysis (EMPA).

According to the invention, color information for each of the plurality of first catalyst samples is first determined. Preferably, a digital image, e.g., a micrograph, for each of the plurality of first catalyst samples is obtained. An imaging device is used to obtain the first color information. Preferably, the imaging device is selected from the group consisting of a digital camera, photographic camera, optical scanner, optical microscope, and densitometer. Optionally, the digital image comprises a gray scale digital image. The digital image can also comprise spectral or hyper-spectral information. The spectral information can be of visible, infra-red, or other wavelength, and can provide correlative information for the determination of coke content.

A luminance value for each pixel in the digital image can be determined. For purposes of the present specification and appended claims, “luminance” is defined as calibrated intensity obtained from either a color image or a gray-scale image. Values for luminance can be based on any acceptable color standard and numerical range, particularly integer ranges. For example, luminance values can be based on 8, 16, 32 or 64 bit values over any desired numerical range, such as from 0 to 1000. As one specific example, luminance value is comprised of an 8 bit value that ranges from 0 to 255. Luminance values can also be based on one or more colors, including gray-scale colors. Examples include red color information, green color information, blue color information or a combination of red, green and/or blue color information. Obtaining such red, green and/or blue color information can be achieved by obtaining luminance information of light that is filtered through a red, green and/or blue color filter. Thus, the color information optionally comprises red color information, green color information, blue color information, a combination of red, green and/or blue color information, and/or gray scale color information.

First images preferably are obtained for each of the plurality of first catalyst samples. Each first image may comprise background color information and color information that is based on the catalyst particles. In this embodiment, each first image preferably is processed with a processing tool, e.g., Adobe™ Photo Shop™, in order to segment the color information that is based on the catalyst particles from background color information. Thus, each first image optionally is segmented to form a segmented image. In the segmenting process, the color information is modified to exclude color information that is based on the background. Ideally, the resulting segmented color information comprises at least 95 percent color information based on catalyst particles, more preferably at least 99 percent color information based on catalyst particles and more preferably at least about 99.9 percent color information based on catalyst particles. By maximizing the amount of color information that corresponds to the catalyst particles at the expense of background color information, the accuracy of the correlation between the color information and coke on catalyst levels can be advantageously maximized. It is contemplated, however, that the segmented color information may comprise a minor amount of color information that is based on the background.

In one embodiment, the catalyst samples comprise spherical particles. As the sides of generally spherical catalyst particles will receive less incident light than the tops of the spherical particles, the sides of the spherical particles tend to be more shaded than the central regions of the catalyst particles. It has been determined that color information based on shaded regions of spherical catalyst particles is less correlatable to coke on catalyst levels than color information that is based on the central region of a catalyst particle. That is, the central region of a catalyst particle tends to reflect the most light and therefore provide color information that can be most accurately correlated with coke on catalyst levels as such color information is generally normal to incident illumination. Thus, the color information preferably comprises information relating to the luminance (gray, red, green and/or blue color information) of the central regions of the plurality of first catalyst samples. By “central region” it is meant the central surface region of a generally spherical particle when viewed from above, using an appropriate light source.

Using image processing and/or manual methods, N areas or “blobs” of picture elements (e.g., pixels) are selected in one or more digital images. Ideally, each “blob” corresponds with color information of the central region of an individual catalyst particle. It is contemplated that at least some of the blobs may comprise color information based on only a portion of the central regions of individual catalyst particles because the central regions of at least some of the catalyst particles will be obscured by overlying catalyst particles. Preferably, the color information is based on the central regions of the catalyst particles (and excludes the darker outer edges of each particle) because the color information obtained at the central region of a spherical catalyst particle provides information that can be best correlated to coke on catalyst levels. In a preferred embodiment,
R_{blob}=(x)·(R_{particle})

wherein
R_{blob} is the radius of a circular blob,
x is any number between 0 and 1, e.g., 0.25, 0.3, 0.5 or 0.75,
and R_{particle} is the radius of a generally spherical catalyst particle,
R_{blob} and R_{radius} having the same center point.
   Although generally spherical catalyst particles are preferred, it is contemplated that the catalyst particles may be cubical, rectangular, ellipsoid-of-revolution, plate-like or irregular powders.

Each catalyst sample has a respective total amount of catalyst particles, Nₜₒₜₐₗ. It is contemplated that some of Nₜₒₜₐₗ catalyst particles in a catalyst sample may be obscured by overlying catalyst particles. That is, only a certain amount of catalyst particles in a given sample will be within the field of view of the imaging device, e.g., camera. These visible catalyst particles are designated herein as N_{visible}, and each of N_{visible} particles has a respective blob associated with it.

Preferably, color information, e.g., gray, red, green and/or blue color information, is obtained for each blob. Initially obtained color information for a single blob may comprise many (N_{pixels/i}) pixels. Preferably, the N_{pixel/i} pixels corresponding to a single blob are averaged to provide an average image intensity V(i) for an individual blob, i. Ideally, an average image intensity value is calculated for each of N_{visible} blobs. The average image intensity, V(i), for a single catalyst particle, i, may be obtained by adding together the image intensity values (luminosity values) for each pixel within a blob and dividing the total by the number of pixels in the blob, as shown by the following equation:

$$V ( i ) = \frac{{Σ}_{blob} {V}_{i} ( x , y )}{{N}_{pixels / i}}$$

wherein Vᵢ(x,y) is the image intensity value (pixel luminosity value) at the i^{th} particle at image pixel position x, y; and
N_{pixels/i} is the number of pixels in the blob corresponding with the i^{th} particle.

The color information that corresponds with the N_{visible} blobs, cumulatively, can be used to determine the overall and individual color luminances for the N_{visible} catalyst particles.

Any of a variety of different calculation processes may be used to determine the N_{visible} values for V(i). For example, N_{visible} values for V(i) may be computed from an optical imaging method, mechanical use of fiber optics or other light pipes to select individual particles, micro- or nanotechnology methods for isolating individual pellets (e.g. single pellets in microreactors), and/or from fluid dynamics techniques such as flow cytometry.

Prior to obtaining the first color information, each of the first plurality of catalyst particles optionally is reduced to a powder of catalyst pellets. This conversion of the catalyst particles to powder may be achieved by crushing the catalyst particles, for example using a mortar and pestle. The powder then may be optically analyzed. One method comprises spreading the pellets (preferably spherical) on a support. The support optionally comprises a clear substance, e.g., glass, a support having a white background, e.g., filter paper, or a non-reflective support, e.g., black paper, so that the luminance of the background can be easily segmented from the catalyst pellets. Light preferably is shined on the catalyst sample from a light source. Normal incident reflective light sources are preferred.

A histogram can also be prepared by sorting pixels of the digital image by luminance value. A histogram is a graphical representation of the total tonal distribution of luminosity in a specific digital image. In one embodiment, the histogram is a bar chart of the count of pixels of a specific digital image for each tone of gray. Each pixel in a digital image has a luminance value, preferably a luminance value ranging from 0 to 255. The histogram graphs the pixel count of each luminance value. Specifically, the x-axis typically represents the range of luminance values, e.g., from 0 to 255, and the y-axis typically represents the number of pixels.

In an alternative embodiment, the histogram is a bar chart of the count of average image intensities for each of N_{visible} particles in a specific digital image. Thus, each blob has a corresponding average image intensity which accounts for a single unit on the histogram. Each bar on the histogram should correspond to a single image intensity value (e.g., 0-255 luminance values as discussed above) or a range of image intensity values. If each bar corresponds to a range of image intensity values, the range for each bar may vary widely, but preferably ranges from about 2 to about 20 luminance values, or from about 4 to about 10 luminance values.

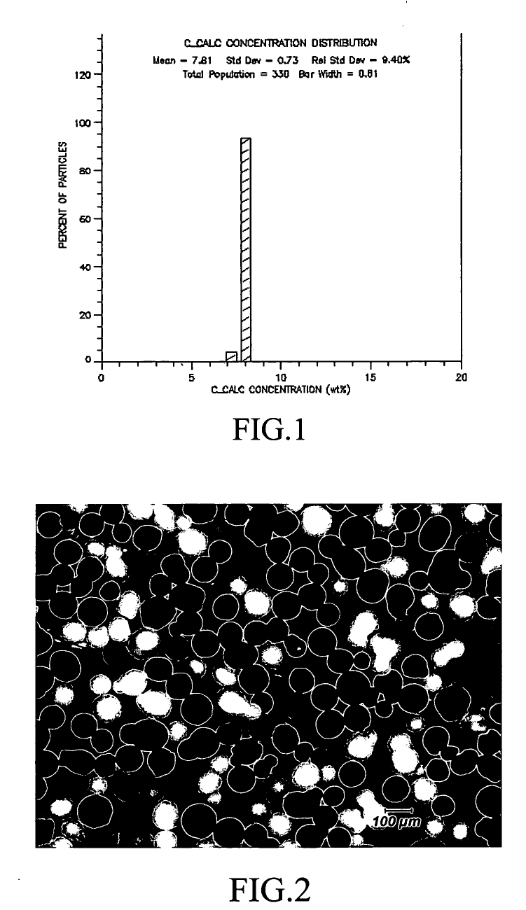

Preparing a histogram is particularly desirable in that it provides a coke distribution of catalyst particles. Catalyst samples containing the catalyst particles are preferably homogenous, and have a relatively uniform coke on catalyst level. As a result, each catalyst sample should exhibit a narrow range of luminance values (approaching a delta function) rather than a broad range of luminance values. On a histogram, the characteristic narrow range of luminance values for a respective catalyst sample should be reflected as a single relatively sharp peak rather than a broad peak. FIG. 1 illustrates a histogram based on color information of a sample showing a single relatively sharp peak.

Each of the catalyst samples has a different coke on catalyst level and a correspondingly different range of luminance values. On histograms, these different ranges of luminance values for each respective catalyst sample is reflected as various sharp peaks. Each respective sharp peak having a greater median luminance value for each progressively more coked first catalyst sample.

In one aspect of the invention, the process comprises determining a color correlation that establishes a quantitative relationship between the first color information and the known coke content for the plurality of first catalyst samples. This step involves the implementation of one or more protocols to provide a correlation between the first color information, e.g., digital information, and the known coke content of each of the plurality of first catalyst samples.

The type of correlation that is obtained will vary widely depending, for example, on the reaction at issue, the type of catalyst used and the reaction conditions. In OTO reaction systems, it has been determined that the correlation should be a generally linear relationship. In other reaction systems or in certain OTO reaction systems it is contemplated that the relationship between the color information and the coke on catalyst levels may be non-linear.

In a preferred embodiment, the color information, preferably the average image intensity values for each of N_{visible} blobs in a given sample, e.g., in a first catalyst sample, is plotted against the known coke content for the first catalyst sample. The resulting plot can be regressed through known mathematical techniques to provide a best-fit linear relationship. The degree to which the correlation provides a linear relationship can be determined by the R² value, which preferably approaches 1.0.

Once a linear relationship is established between the color information and the coke on catalyst levels, the slope (m) and y-intercept (b) can be easily determined to provide the relationship:
C(i)_{unknown}=mV(i)_{unknown}+b
wherein C(i)_{unknown} is the optically determined coke level of i^{th} particle having an unknown coke on catalyst level; and V(i)_{unknown} is the average image intensity of the i^{th} particle (or the blob corresponding to the i^{th} particle), determined in the same manner as described above with reference to the first catalyst samples.

The color correlation e can be used to determine an optically determined coke on catalyst level C(i)_{unknown} for a catalyst sample having an unknown coke on catalyst content. Coke content distribution profiles can also be obtained based on color information of an unknown catalyst sample. The processes for utilizing a correlation on an unknown catalyst sample to determine the unknown catalyst sample's coke on catalyst level will now be described.

### C. Processes for Determining Coke Content on

### Catalysts

In another preferred embodiment, the process comprises a step of determining second color information for a second catalyst sample, with the second catalyst sample having an unknown coke content. The second color information is applied to the color correlation to determine one or more values for the unknown coke content.

In yet another embodiment, the invention is to a process for analytically determining coke content of a second catalyst sample. Preferably, a plurality of first catalyst samples is provided, with each first catalyst sample having a known coke content. First color information is determined for each of the plurality of first catalyst samples, and a color correlation that establishes a quantitative relationship between the first color information and the known coke content for the plurality of first catalyst samples is determined. Second color information for the second catalyst sample, wherein the second catalyst sample has an unknown coke content is determined. Then, the second color information is applied to the color correlation to determine one or more values for the unknown coke content.

As with the embodiments discussed above, this process optionally comprises determining the known coke content for each first catalyst sample. Preferably this is done by combusting coke on a portion of each first catalyst sample in the presence of oxygen and measuring an amount of combustion products yielded by the combusting.

The second color information can be determined in substantially the same manner as determining the first color information for each of the plurality of first catalyst samples. A digital image for each of the plurality of first catalyst samples can be obtained as above. Optionally, a luminance value for each pixel in the digital image can be obtained as above. A histogram representing the luminance values of the digital image can also be used.

A first image preferably is obtained for the second catalyst sample. The first image may comprise background color information and color information that is based on the catalyst particles. In this embodiment, the first image preferably is processed with a processing tool, e.g., Adobe™ Photo Shop™, in order to segment the color information that is based on the catalyst particles from background color information. Thus, the first image optionally is segmented to form a segmented image. In the segmenting process, the color information is modified to exclude color information that is based on the background. Ideally, the resulting segmented color information comprises at least 95 percent color information based on catalyst particles, more preferably at least 99 percent color information based on catalyst particles and more preferably at least about 99.9 percent color information based on catalyst particles. By maximizing the amount of color information that corresponds to the catalyst particles at the expense of background color information, the accuracy of the correlation between the color information and coke on catalyst levels can be advantageously maximized. It is contemplated, however, that the segmented color information may comprise a minor amount of color information that is based on the background.

In one embodiment, the plurality of first catalyst samples comprises spheroid catalyst particles. As the sides of generally spherical catalyst particles will receive less incident light than the tops of the spherical particles, the sides of the spherical particles tend to be more shaded than the central regions of the catalyst particles. It has been determined that color information based on shaded regions of spherical catalyst particles is less correlatable to coke on catalyst levels than color information that is based on the central region of a catalyst particle. That is, the central region of a catalyst particle tends to reflect the most light and therefore provide color information that can be most accurately correlated with coke on catalyst levels as such color information is generally normal to incident illumination. Thus, the color information preferably comprises information relating to the luminance (gray, red, green and/or blue color information) of the central regions of the second catalyst sample.

The first color information optionally comprises central color information based on central regions of the spheroid catalyst particles. Similarly, the second catalyst sample optionally comprises spheroid catalyst particles. The second color information optionally comprises central color information based on central regions of the spheroid catalyst particles. The second catalyst sample optionally is withdrawn, on-line or off-line, from a reaction system. By “on-line” it is meant that the second catalyst sample is withdrawn from the reaction system while the reaction system is in normal operation, and “off-line” means that the second catalyst sample is withdrawn from a reactor that has been shut down.

In one embodiment, the optically determined coke level for each of N_{visible} particles in an unknown catalyst sample can be determined based on the above-described correlation between the color information and the coke on catalyst levels. These optically determined coke levels can be arranged in a histogram in a manner similar to the process described above with reference to the histograms for the first catalyst samples. The benefit of providing a histogram for the unknown catalyst sample, however, is that the histogram graphically illustrates the coke distribution within the unknown sample. In an alternate embodiment, a histogram is created which comprises values for the average image intensities for each of N_{visible} blobs for an unknown sample without correlating the average image intensities to their respective optically determined coke levels.

While the correlation between the color information and the coke on catalyst information preferably is a linear relationship, as discussed above, it is contemplated that the correlation may be non-linear and still provide an adequate predictor of coke on catalyst level based on color information according to the function:
C_{optical}(i)=f(V(i))V(i)

The second catalyst sample need not be homogenous. It is contemplated that a normal second catalyst sample from an operational OTO reaction system will contain a mixture of catalyst particles having a wide range of different coke on catalyst levels. This broad coke distribution is caused by the removal of some catalyst particles for regeneration as well as to the reintroduction of new virgin catalyst particles and/or of regenerated catalyst particles. FIG. 2 illustrates an image of a population of catalyst particles having a wide coke distribution. Darker catalyst particles generally have higher coke on catalyst levels than the lighter catalyst particles.

In a particular embodiment, the invention is to a process for analytically determining coke content of a catalyst sample. This process comprises the steps of: (a) providing a color correlation that correlates coke content as a function of color information; (b) determining color information for the catalyst sample, wherein the catalyst sample has an unknown coke content; and (c) applying the color information to the color correlation to determine one or more values for the unknown coke content. In this embodiment, the color correlation provided in step (a) optionally is determined according to the embodiment of the present invention described above.

In another preferred embodiment, the invention is to a process for monitoring coke-on-catalyst content in an oxygenate to olefin reaction system. The process comprises the steps of: (a) contacting an oxygenate-containing feedstock with a catalyst composition in a reaction zone under conditions effective to convert at least a portion of the oxygenate-containing feedstock to light olefins; (b) withdrawing a first portion of catalyst particles from the reaction zone; (c) providing a color correlation that correlates coke content as a function of color information; (d) determining color information of the first portion, wherein the first portion has an unknown coke content; and (e) applying the color information to the color correlation to determine one or more values for the unknown coke content.

In a preferred embodiment, a digital image of the catalyst sample is obtained. Optionally, a luminance value for each pixel in the digital image is obtained as described above.

### D. Catalyst and Reaction Processes

The invention can be used to detect coke on catalyst that is used in a variety of reaction processes. Examples of such processes include: oxygenate to olefins, catalytic cracking, hydroforming, phthalic anhydride, maleic anhydride, Fischer-Tropsch synthesis, vinyl acetate, acrylonitrile, ethylene dichloride, chloromethane, polyethylene, and polypropylene. As used herein, “reaction system” means a system comprising a reactor, optionally a catalyst regenerator, optionally a catalyst cooler and optionally a catalyst stripper.

In one embodiment, the catalyst that can be used in the invention is a molecular sieve catalyst. In a preferred embodiment, the molecular sieve catalyst comprises an alumina or a silica-alumina molecular sieve.

Silicoaluminophosphate (SAPO) molecular sieve catalysts are one particular embodiment. A non-limiting list of preferable SAPO molecular sieve catalyst compositions includes SAPO-17, SAPO-18, SAPO-34, SAPO-35, SAPO-44, the substituted forms thereof, and mixtures thereof. Preferably, the molecular sieve catalyst composition comprises a molecular sieve selected from the group consisting of: SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

In another preferred embodiment, the catalyst particles are selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, ALPO-5, ALPO-11, ALPO-18, ALPO-31, ALPO-34, ALPO-36, ALPO-37, ALPO-46, and metal containing molecular sieves thereof. Intergrowths or intergrown forms are also included.

In another preferred embodiment, one or more molecular sieves can be an intergrowth material having two or more distinct phases of crystalline structures within one molecular sieve composition. Examples of intergrowth molecular sieves useful in this invention include those described in U.S. Patent Application Publication No. 2002-0165089 and International Publication No. WO 98/15496, published Apr. 16, 1998, the descriptions of those sieves incorporated herein by reference. Note that SAPO-18, AlPO-18 and RUW-18 have an AEI framework-type, and SAPO-34 has a CHA framework-type, and that preferred molecular sieves used herein may comprise at least one intergrowth phase of AEI and CHA framework-types, especially where the ratio of CHA framework-type to AEI framework-type, as determined by the DIFFaX method disclosed in U.S. Patent Application Publication No. 2002-0165089, is greater than 1:1.

In one embodiment, the invention concerns detecting coke on catalyst levels in an OTO reaction system. In an OTO reaction system, an oxygenate-containing feedstock is fed into an OTO reactor. The feedstock that is directed to an OTO reaction system optionally contains one or more aliphatic-containing compounds such as alcohols, amines, carbonyl compounds for example aldehydes, ketones and carboxylic acids, ethers, halides, mercaptans, sulfides, and the like, and mixtures thereof. The aliphatic moiety of the aliphatic-containing compounds typically contains from 1 to about 50 carbon atoms, preferably from 1 to 20 carbon atoms, more preferably from 1 to 10 carbon atoms, and more preferably from 1 to 4 carbon atoms, and most preferably methanol.

Non-limiting examples of aliphatic-containing compounds include: alcohols such as methanol and ethanol, alkyl-mercaptans such as methyl mercaptan and ethyl mercaptan, alkyl-sulfides such as methyl sulfide, alkyl-amines such as methyl amine, alkyl-ethers such as DME, diethyl ether and methylethyl ether, alkyl-halides such as methyl chloride and ethyl chloride, alkyl ketones such as dimethyl ketone, alkyl-aldehydes such as formaldehyde and acetaldehyde, and various acids such as acetic acid.

In a preferred embodiment of the process of the invention, the feedstock contains one or more organic compounds containing at least one oxygen atom. In the most preferred embodiment of the process of invention, the oxygenate in the feedstock comprises one or more alcohols, preferably aliphatic alcohols where the aliphatic moiety of the alcohol(s) has from 1 to 20 carbon atoms, preferably from 1 to 10 carbon atoms, and most preferably from 1 to 4 carbon atoms. The alcohols useful as feedstock in the process of the invention include lower straight and branched chain aliphatic alcohols and their unsaturated counterparts. Non-limiting examples of oxygenates include methanol, ethanol, n-propanol, isopropanol, methyl ethyl ether, DME, diethyl ether, di-isopropyl ether, formaldehyde, dimethyl carbonate, dimethyl ketone, acetic acid, and mixtures thereof. In the most preferred embodiment, the feedstock comprises one or more of methanol, ethanol, DME, diethyl ether or a combination thereof.

The various feedstocks discussed above are converted primarily into one or more olefins. The olefins or olefin monomers produced from the feedstock typically have from 2 to 30 carbon atoms, preferably 2 to 8 carbon atoms, more preferably 2 to 6 carbon atoms, still more preferably 2 to 4 carbons atoms, and most preferably ethylene and/or propylene.

Non-limiting examples of olefin monomer(s) include ethylene, propylene, butene-1, pentene-1,4-methyl-pentene-1, hexene-1, octene-1 and decene-1, preferably ethylene, propylene, butene-1, pentene-1,4-methyl-pentene-1, hexene-1, octene-1 and isomers thereof. Other olefin monomers include unsaturated monomers, diolefins having 4 to 18 carbon atoms, conjugated or nonconjugated dienes, polyenes, vinyl monomers and cyclic olefins.

In a preferred embodiment, the feedstock, which ideally contains methanol, is converted in the presence of a molecular sieve catalyst composition into olefin(s) having 2 to 6 carbons atoms, preferably 2 to 4 carbon atoms. Most preferably, the olefin(s), alone or combination, are converted from a feedstock containing an oxygenate, preferably an alcohol, most preferably methanol, to the preferred olefin(s) ethylene and/or propylene.

The most preferred process is generally referred to as an oxygenate-to-olefins (OTO) reaction process. In an OTO process, typically an oxygenated feedstock, most preferably a methanol- and ethanol-containing feedstock, is converted in the presence of a molecular sieve catalyst composition into one or more olefins, preferably and predominantly, ethylene and/or propylene, referred to herein as light olefins.

The feedstock, in one embodiment, contains one or more diluents, typically used to reduce the concentration of the feedstock. The diluents are generally non-reactive to the feedstock or molecular sieve catalyst composition. Non-limiting examples of diluents include helium, argon, nitrogen, carbon monoxide, carbon dioxide, water, essentially non-reactive paraffins (especially alkanes such as methane, ethane, and propane), essentially non-reactive aromatic compounds, and mixtures thereof. The most preferred diluents are water and nitrogen, with water being particularly preferred. In other embodiments, the feedstock does not contain any diluent.

The diluent may be used either in a liquid or a vapor form, or a combination thereof. The diluent is either added directly to a feedstock entering into a reactor or added directly into a reactor, or added with a molecular sieve catalyst composition. In one embodiment, the amount of diluent in the feedstock is in the range of from about 1 to about 99 mole percent based on the total number of moles of the feedstock and diluent, preferably from about 1 to 80 mole percent, more preferably from about 5 to about 50, most preferably from about 5 to about 25. In one embodiment, other hydrocarbons are added to a feedstock either directly or indirectly, and include olefin(s), paraffin(s), aromatic(s) or mixtures thereof, preferably propylene, butylene, pentylene, and other hydrocarbons having 4 or more carbon atoms, or mixtures thereof.

The process for converting a feedstock, especially a feedstock containing one or more oxygenates, in the presence of a molecular sieve catalyst composition of the invention, is carried out in a reaction process in a reactor, where the process is a fixed bed process, a fluidized bed process (includes a turbulent bed process), preferably a continuous fluidized bed process, and most preferably a continuous high velocity fluidized bed process.

The reaction processes can take place in a variety of catalytic reactors such as hybrid reactors that have a dense bed or fixed bed reaction zones and/or fast fluidized bed reaction zones coupled together, circulating fluidized bed reactors, riser reactors, and the like. Suitable conventional reactor types are described in for example U.S. Pat. No. 4,076,796, U.S. Pat. No. 6,287,522 (dual riser), and Fluidization Engineering, D. Kunii and O. Levenspiel, Robert E. Krieger Publishing Company, New York, N.Y. 1977.

The preferred reactor type are riser reactors generally described in Riser Reactor, Fluidization and Fluid-Particle Systems, pages 48 to 59, F. A. Zenz and D. F. Othmer, Reinhold Publishing Corporation, New York, 1960, and U.S. Pat. No. 6,166,282 (fast-fluidized bed reactor), and U.S. patent application Ser. No. 09/564,613 filed May 4, 2000 (multiple riser reactor).

In one embodiment, the amount of liquid feedstock fed separately or jointly with a vapor feedstock, to a reactor system is in the range of from 0.1 weight percent to about 85 weight percent, preferably from about 1 weight percent to about 75 weight percent, more preferably from about 5 weight percent to about 65 weight percent based on the total weight of the feedstock including any diluent contained therein. The liquid and vapor feedstocks are preferably the same composition, or contain varying proportions of the same or different feedstock with the same or different diluent.

The conversion temperature employed in the conversion process, specifically within the reactor system, is in the range of from about 392° F. (200° C.) to about 1832° F. (1000° C.), preferably from about 482° F. (250° C.) to about 1472° F. (800° C.), more preferably from about 482° F. (250° C.) to about 1382° F. (750° C.), yet more preferably from about 572° F. (300° C.) to about 1202° F. (650° C.), yet even more preferably from about 662° F. (350° C.) to about 1112° F. (600° C.) most preferably from about 662° F. (350° C.) to about 1022° F. (550° C.).

The conversion pressure employed in the conversion process, specifically within the reactor system, varies over a wide range including autogenous pressure. The conversion pressure is based on the partial pressure of the feedstock exclusive of any diluent therein. Typically the conversion pressure employed in the process is in the range of from about 0.1 kPaa to about 5 MPaa, preferably from about 5 kPaa to about 1 MPaa, and most preferably from about 20 kPaa to about 500 kPaa.

The weight hourly space velocity (WHSV), particularly in a process for converting a feedstock containing one or more oxygenates in the presence of a molecular sieve catalyst composition within a reaction zone, is defined as the total weight of the feedstock excluding any diluents to the reaction zone per hour per weight of molecular sieve in the molecular sieve catalyst composition in the reaction zone. The WHSV is maintained at a level sufficient to keep the catalyst composition in a fluidized state within a reactor.

Typically, the WHSV ranges from about 1 hr⁻¹ to about 5000 hr⁻¹, preferably from about 2 hr⁻¹ to about 3000 hr⁻¹, more preferably from about 5 hr⁻¹ to about 1500 hr⁻¹, and most preferably from about 10 hr⁻¹ to about 1000 hr⁻¹. In one preferred embodiment, the WHSV is greater than 20 hr⁻¹, preferably the WHSV for conversion of a feedstock containing methanol, DME, or both, is in the range of from about 20 hr⁻¹ to about 300 hr⁻¹.

The superficial gas velocity (SGV) of the feedstock including diluent and reaction products within the reactor is preferably sufficient to fluidize the molecular sieve catalyst composition within a reaction zone in the reactor. The SGV in the process, particularly within the reactor system, more particularly within the riser reactor(s), is at least 0.1 meter per second (m/sec), preferably greater than 0.5 m/sec, more preferably greater than 1 m/sec, even more preferably greater than 2 m/sec, yet even more preferably greater than 3 m/sec, and most preferably greater than 4 m/sec. A SGV of from about 15 ft/sec (5 m/s) to about 60 ft/sec (18 m/s) is preferred. See, for example, U.S. patent application Ser. No. 09/708,753, filed Nov. 8, 2000, which is herein incorporated by reference.

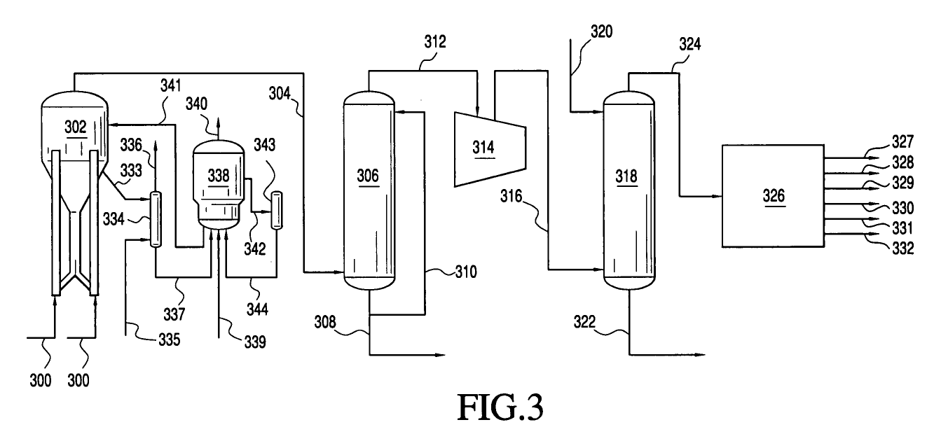

FIG. 3 shows an exemplary OTO reaction system. In the figure, an oxygenate such as methanol is directed through lines 300 to an OTO fluidized reactor 302 wherein the oxygenate is converted to light olefins and various by-products which are yielded from the fluidized reactor 302 in an olefin-containing stream in line 304. The olefin-containing stream in line 304 optionally comprises methane, ethylene, ethane, propylene, propane, various oxygenate byproducts, C4+ olefins, water and hydrocarbon components. The olefin-containing stream in line 304 is directed to a quench unit or quench tower 306 wherein the olefin-containing stream in line 304 is cooled and water and other readily condensable components are condensed.

The condensed components, which comprise water, are withdrawn from the quench tower 306 through a bottoms line 308. A portion of the condensed components are recycled through a line 310 back to the top of the quench tower 306. The components in line 310 preferably are cooled in a cooling unit, e.g., heat exchanger (not shown), so as to provide a cooling medium to cool the components in quench tower 306.

An olefin-containing vapor is yielded from the quench tower 306 through overhead stream 312. The olefin-containing vapor is compressed in one or more compressors 314 and the resulting compressed olefin-containing stream is optionally passed through line 316 to a water absorption unit 318. Methanol is preferably used as the water absorbent, and is fed to the top portion of the water absorption unit 318 through line 320. Methanol and entrained water, as well as some oxygenates, are separated as a bottoms stream through line 322. The light olefins are recovered through overhead line 324. Optionally, the light olefins are sent to an additional compressor or compressors (not shown), and then are input to a separation system 326, which optionally comprises one or more separation units such as distillation columns, absorption units, and/or adsorption units.

The separation system 326 separates the components contained in the overhead line 324. Thus, separation system 326 forms a light ends stream 327, optionally comprising methane, hydrogen and/or carbon monoxide; an ethylene-containing stream 328 comprising mostly ethylene; an ethane-containing stream 329 comprising mostly ethane; a propylene-containing stream 330 comprising mostly propylene; a propane-containing stream 331 comprising mostly propane; and one or more byproduct streams, shown as line 332, comprising one or more of the oxygenate byproducts, provided above, heavy olefins, heavy paraffins, and/or absorption mediums utilized in the separation process. Separation processes that may be utilized to form these streams are well-known and are described, for example, in pending U.S. patent application Ser. Nos. 10/124,859 filed Apr. 18, 2002; Ser. No. 10/125,138 filed Apr. 18, 2002; Ser. No. 10/383,204 filed Mar. 6, 2003; and Ser. No. 10/635,410 filed Aug. 6, 2003, the entireties of which are incorporated herein by reference.

FIG. 3 also illustrates a catalyst regeneration system, which is in fluid communication with fluidized reactor 302. As shown, at least a portion of the catalyst compositions contained in fluidized reactor 302 are withdrawn and transported, preferably in a fluidized manner, in conduit 333 from the fluidized reactor 302 to a catalyst stripper 334. In the catalyst stripper 334, the catalyst compositions contact a stripping medium, e.g., steam and/or nitrogen, under conditions effective to remove interstitial hydrocarbons from the molecular sieve catalyst compositions. As shown, stripping medium is introduced into catalyst stripper 334 through line 335, and the resulting stripped stream 336 is released from catalyst stripper 334. Optionally, all or a portion of stripped stream 336 is directed back to fluidized reactor 302.

During contacting of the oxygenate feedstock with the molecular sieve catalyst composition in the fluidized reactor 302, the molecular sieve catalyst composition may become at least partially deactivated. That is, the molecular sieve catalyst composition becomes at least partially coked. In order to reactivate the molecular sieve catalyst composition, the catalyst composition preferably is directed to a catalyst regenerator 338. As shown, the stripped catalyst composition is transported, preferably in the fluidized manner, from catalyst stripper 334 to catalyst regenerator 338 in conduit 337. Preferably, the stripped catalyst composition is transported in a fluidized manner through conduit 337.

In catalyst regenerator 338, the stripped catalyst composition contacts a regeneration medium, preferably comprising oxygen, under conditions effective (preferably including heating the coked catalyst) to at least partially regenerate the catalyst composition contained therein. As shown, the regeneration medium is introduced into the catalyst regenerator 338 through line 339, and the resulting regenerated catalyst compositions are ultimately transported, preferably in a fluidized manner, from catalyst regenerator 338 back to the fluidized reactor 302 through conduit 341. The gaseous combustion products are released from the catalyst regenerator 338 through flue gas stream 340. In another embodiment, not shown, the regenerated catalyst composition additionally or alternatively is directed, optionally in a fluidized manner, from the catalyst regenerator 338 to one or more of the fluidized reactor 302 and/or the catalyst stripper 334. In one embodiment, not shown, a portion of the catalyst composition in the reaction system is transported directly, e.g., without first passing through the catalyst stripper 334, optionally in a fluidized manner, from the fluidized reactor 302 to the catalyst regenerator 338.

As the catalyst compositions contact the regeneration medium in catalyst regenerator 338, the temperature of the catalyst composition may increase due to the exothermic nature of the regeneration process. As a result, it may be desirable to control the temperature of the catalyst composition by directing at least a portion of the catalyst composition from the catalyst regenerator 338 to a catalyst cooler 343. As shown, the catalyst composition is transported in a fluidized manner from catalyst regenerator 338 to the catalyst cooler 343 through conduit 342. The resulting cooled catalyst composition is transported, preferably in a fluidized manner from catalyst cooler 343 back to the catalyst regenerator 338 through conduit 344. In another embodiment, not shown, the cooled catalyst composition additionally or alternatively is directed, optionally in a fluidized manner, from the catalyst cooler 343 to one or more of the fluidized reactor 302 and/or the catalyst stripper 334.

During the catalytic conversion of hydrocarbons to various products, e.g., the catalytic conversion of oxygenates to light olefins (the OTO process), carbonaceous deposits accumulate on the catalyst used to promote the conversion reaction. At some point, the build up of these carbonaceous deposits causes a reduction in the capability of the catalyst to function efficiently. For example, in the OTO process, an excessively “coked” catalyst does not readily convert the oxygenate feed to light olefins. At this point, the catalyst is partially deactivated. When a catalyst can no longer convert the hydrocarbon to the desired product, the catalyst is considered to be fully deactivated. The catalyst regenerator of the present invention efficiently removes at least a portion of the carbonaceous deposits from an at least partially coked catalyst composition to form a regenerated catalyst composition having increased catalytic activity over the at least partially coked catalyst composition.

In accordance with the present invention, catalyst is withdrawn from a hydrocarbon conversion apparatus (HCA), e.g., a reactor or reaction unit, and is directed to a catalyst regenerator. Preferably, the HCA is an OTO reactor, and most preferably a methanol to olefin (MTO) reactor. The catalyst is partially, if not fully, regenerated in the catalyst regenerator. By regeneration, it is meant that the carbonaceous deposits are at least partially removed from the catalyst. Desirably, the catalyst withdrawn from the HCA is at least partially coked and, thus, at least partially deactivated. The remaining portion of catalyst in the HCA is re-circulated in the HCA without regeneration. The regenerated catalyst, with or without cooling, is then returned to the HCA.

Desirably, a portion of the catalyst, comprising molecular sieve and any other materials such as matrix materials, binders, fillers, etc., is removed from the HCA for regeneration and recirculation back to the HCA at a rate (catalyst weight/hour) of from about 0.05 times to about 1 times, more desirably from about 0.1 times to about 0.5 times, and most desirably from about 0.1 to about 0.3 times the total feed rate (oxygenate weight/hour) of oxygenates to the HCA. These rates pertain to the formulated molecular sieve catalyst composition, including non-reactive solids.

Desirably, the catalyst regeneration is carried out in a catalyst regenerator in the presence of a regeneration medium, typically a gas, comprising molecular oxygen or other oxidants. Examples of other oxidants include, but are not necessarily limited to, singlet O₂, O₃, SO₃, N₂O, NO, NO₂, N₂O₅, and mixtures thereof. Air and air diluted with nitrogen or CO₂ are particularly desirable regeneration mediums. The oxygen concentration in air can be reduced to a controlled level to minimize overheating of, or creating hot spots in, the catalyst regenerator. The catalyst can also be regenerated reductively with hydrogen, mixtures of hydrogen and carbon monoxide, or other suitable reducing gases.

The catalyst can be regenerated in any number of methods, such as batch, continuous, semi-continuous, or a combination thereof. Continuous catalyst regeneration is a desired method. Desirably, the catalyst is regenerated to a level of remaining coke from about 0.01 weight percent to about 15 weight percent, more preferably from about 0.01 to about 5 weight percent, based on the total weight of the regenerated catalyst composition.

The catalyst regeneration temperature should be from about 250° C. to about 750° C., and optionally from about 500° C. to about 700° C. Preferably the contacting of the coked catalyst with the regeneration medium in the regeneration zone occurs at a temperature of at least about 538° C., at least 649° C., or at least 710° C. Because the regeneration reaction preferably takes place at a temperature considerably higher than the OTO conversion reaction, e.g., about 93° C. to about 150° C. higher, it is desirable to cool at least a portion of the regenerated catalyst to a lower temperature before it is sent back to the HCA. One or more catalyst coolers, preferably located externally to the catalyst regenerator, optionally are used to remove heat from the regenerated catalyst after it has been withdrawn from the catalyst regenerator. When the regenerated catalyst is cooled, it is optionally cooled to a temperature that is from about 70° C. higher to about 80° C. cooler than the temperature of the catalyst withdrawn from the HCA. This cooled catalyst is then returned to either some portion of the HCA, the catalyst regenerator, or both. When the regenerated catalyst from the catalyst regenerator is returned to the HCA, it can be returned to any portion of the HCA. For example, the catalyst can be returned to a catalyst containment area to await contact with the feed, a separation zone to contact products of the feed or a combination of both.

Ideally, regeneration occurs in the catalyst regenerator at a pressure of from about 5 psig (34.5 kPag) to about 50 psig (345 kPag), preferably from about 15 psig (103 kPag) to about 40 psig (276 kPag), and most preferably from about 20 psig (138 kPag) to about 30 psig (207 kPag). The precise regeneration pressure is dictated by the pressure in the HCA. Higher pressures are generally preferred for lowering equipment size and catalyst inventory, however, higher pressures increase air blower power and cost.

Desirably, catalyst regeneration is carried out after the at least partially deactivated catalyst has been stripped of most of the readily removable organic materials (organics), e.g., interstitial hydrocarbons, in a stripper or stripping chamber. This stripping can be achieved by passing a stripping medium, e.g., a stripping gas, over the spent catalyst at an elevated temperature. Gases suitable for stripping include steam, nitrogen, helium, argon, methane, CO2, CO, hydrogen, and mixtures thereof. A preferred gas is steam. The gas hourly space velocity (GHSV) of the stripping gas, based on volume of gas to volume of catalyst and coke, is from about 0.1 hr⁻¹ to about 20,000 hr⁻¹. Acceptable temperatures of stripping are from about 250° C. to about 750° C., and desirably from about 400° C. to about 600° C. Acceptable stripping pressures are from about 5 psig (34.5 kPag) to about 50 psig (344 kPag), more preferably from about 10 psig (69.0 kPag) to about 30 psig (207 kPag), and most preferably from about 20psig (138 kPag) to about 25 psig (172 kPag). The stripping pressure is largely dependent upon the pressure in the HCA and in the catalyst regenerator.

### EXAMPLE

The present invention will be better understood by the following non-limiting example.

In the Example, 13 formulated SAPO-34 catalyst samples were prepared, each sample having a different coke on catalyst level. One formulated SAPO-34 catalyst sample (sample 1) comprised virgin molecular sieves. In order to provide catalyst particles having differing coke on catalyst levels, each of the samples was exposed to methanol under reaction conditions (10 WHSV, 475° C., and 25 psig (172 kPag)) for a different period of time. The coke levels ranged from 1.6 weight percent to 8.3 weight percent. The catalyst particles were coked in a 1 inch fluid bed reactor, which provided homogenous coke deposition. All of the particles in a respective sample had the same coke on catalyst level and the coke distribution was very narrow, approaching a Dirac function. The coke on catalyst levels for each of the 12 samples were determined with a LECO CS200.

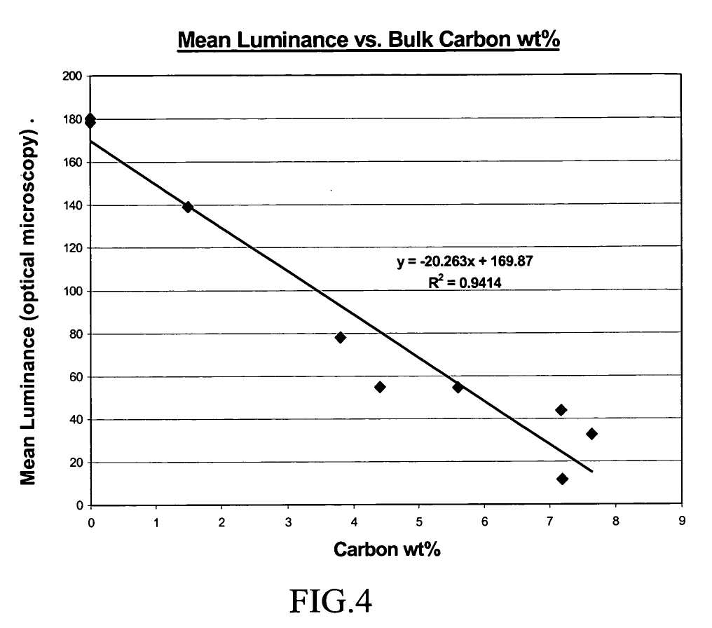

Digital color information was then obtained for each of the 12 samples. The color information was analyzed with Adobe Photo Shop to extract gray scale and RGB histograms for each sample. Table 1, below, shows average coke level, gray scale (luminosity) and RGB means. FIG. 4 shows a graph plotting luminosity and RGB means against coke level for the SAPO-34 catalyst particles.

TABLE I
Luminosity and RGB Means
as a Function of Coke Level for SAPO34 Catalyst

| Sample | Coke Wt. % | Luminosity | Red | Green | Blue |
|---|---|---|---|---|---|
| 1 | 0.00 | 229.41 | 225.81 | 232.39 | 223.68 |
| 2 | 1.64 | 214.55 | 214.56 | 215.55 | 209.68 |
| 3 | 2.16 | 202.04 | 202.12 | 204.09 | 190.73 |
| 4 | 3.65 | 195.01 | 200.28 | 197.84 | 166.98 |
| 5 | 5.19 | 162.18 | 174.76 | 164.74 | 115.97 |
| 6 | 5.71 | 143.12 | 161.09 | 145.15 | 85.88 |
| 7 | 6.20 | 120.21 | 144.15 | 119.23 | 63.20 |
| 8 | 7.14 | 81.41 | 105.41 | 77.41 | 40.88 |
| 9 | 7.83 | 53.74 | 76.88 | 47.92 | 21.73 |
| 10 | 7.82 | 38.48 | 62.33 | 32.19 | 9.45 |
| 11 | 8.21 | 33.08 | 56.50 | 26.18 | 6.98 |
| 12 | 7.95 | 45.53 | 69.42 | 39.42 | 12.20 |
| 13 | 8.32 | 22.61 | 38.14 | 18.10 | 4.64 |

Each of the curves shown in FIG. 4 was regressed to 2d or 3d order polynomial functions.

An image, shown in FIG. 2, was then obtained of an unknown catalyst sample having a mixture of catalyst particles having different coke on catalyst levels. The polynomial functions derived from the curves shown in FIG. 4 were then used to predict the coke on catalyst level for the unknown catalyst sample based on the color information obtained in the image.

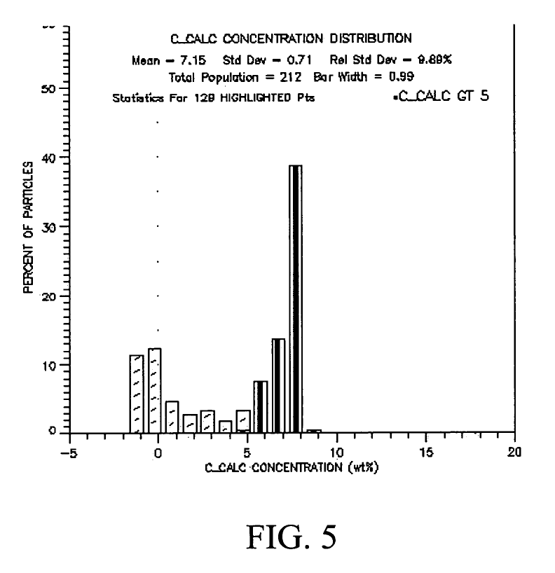

A luminosity histogram was obtained from the color information obtained in the step of imagining the unknown catalyst sample. The relationship described in FIG. 4 was used to produce a coke level distribution. FIG. 5 shows the coke distribution measured with this novel technique.

For comparison purposes, the unknown catalyst sample was analyzed to determine the experimental coke on catalyst level for the unknown catalyst sample.

Having now fully described the invention, it will be appreciated by those skilled in the art that the invention may be performed within a wide range of perimeters within what is claimed, without departing from the spirit and scope of the present invention.

We claim:

1. A process for analytically determining coke content of a catalyst sample, the process comprising the steps of:
(a) providing a color correlation that correlates average coke content on the catalyst and/or the coke level distribution on the catalyst as a function of color information;
(b) determining color information for the catalyst sample, wherein the catalyst sample has an unknown coke content; and
(c) applying the color information to the color correlation to determine one or more values for the unknown coke content.

2. The process of claim 1, wherein a digital image of the catalyst sample is obtained.

3. The process of claim 2, wherein a luminance value for each pixel in the digital image is obtained.

4. The process of claim 2, wherein the digital image comprises a gray scale digital image.

5. The process of claim 3, wherein each luminance value is an 8 bit value that ranges from 0 to 255.

6. The process of claim 3, wherein each luminance value is based on red color information.

7. The process of claim 3, wherein each luminance value is based on green color information.

8. The process of claim 3, wherein each luminance value is based on blue color information.

9. The process of claim 3, wherein each luminance value is based on red, green and blue color information.

10. The process of claim 3, wherein a histogram is prepared representing the luminance values of the digital image.

11. The process of claim 1, wherein the catalyst sample comprises spheroid catalyst particles.

12. The process of claim 1, wherein the color information comprises central color information based on central regions of the spheroid catalyst particles.

13. The process of claim 1, wherein the catalyst in the catalyst sample comprises a molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

14. A process for analytically determining coke content of a catalyst sample, the process comprising the steps of:
(a) providing a plurality of first catalyst samples, each first catalyst sample having a known coke content;
(b) determining first color information for each of the plurality of first catalyst samples;
(c) determining a color correlation that establishes a quantitative relationship between the first color information and the known coke content for the plurality of first catalyst samples;
(d) determining second color information for the second catalyst sample, wherein the second catalyst sample has an unknown coke content; and
(e) applying the second color information to the color correlation to determine one or more values for the unknown coke content.

15. The process of claim 14, wherein the process further comprises the step of determining the known coke content for each first catalyst sample by combusting coke on a portion of each first catalyst sample in the presence of oxygen and measuring an amount of combustion products yielded by the combusting.

16. The process of claim 14, wherein the process further comprises obtaining a digital image for each of the plurality of first catalyst samples.

17. The process of claim 16, wherein the process further comprises obtaining a luminance value for each pixel in the digital image.

18. The process of claim 16, wherein the digital image comprises a gray scale digital image.

19. The process of claim 17, wherein each luminance value is an 8 bit value that ranges from 0 to 255.

20. The process of claim 17, wherein each luminance value is based on red color information.

21. The process of claim 17, wherein each luminance value is based on green color information.

22. The process of claim 17, wherein each luminance value is based on blue color information.

23. The process of claim 17, wherein each luminance value is based on red, green and blue color information.

24. The process of claim 17, wherein the process further comprises preparing a histogram representing the luminance values of the digital image.

25. The process of claim 14, wherein the process further comprises obtaining a digital image for the second catalyst sample.

26. The process of claim 25, wherein the process further comprises obtaining a luminance value for each pixel in the digital image.

27. The process of claim 26, wherein the digital image comprises a gray scale digital image.

28. The process of claim 25, wherein each luminance value is an 8 bit value that ranges from 0 to 255.

29. The process of claim 25, wherein each luminance value is based on red color information.

30. The process of claim 25, wherein each luminance value is based on green color information.

31. The process of claim 25, wherein each luminance value is based on blue color information.

32. The process of claim 25, wherein each luminance value is based on red, green and blue color information.

33. The process of claim 25, wherein the process further comprises preparing a histogram representing the luminance values of the digital image.

34. The process of claim 26, wherein the plurality of first catalyst samples comprise spheroid catalyst particles.

35. The process of claim 34, wherein the first color information comprises central color information based on central regions of the spheroid catalyst particles.

36. The process of claim 14, wherein the plurality of second catalyst samples comprise spheroid catalyst particles.

37. The process of claim 36, wherein the second color information comprises central color information based on central regions of the spheroid catalyst particles.

38. The process of claim 14, wherein the catalyst in the first catalyst samples comprises a molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

39. The process of claim 14, wherein the second catalyst sample is withdrawn, on-line, from a reaction system.

40. The process of claim 14, wherein the second catalyst sample is withdrawn, off-line, from a reaction system.

41. A method for controlling one or more process variables of a hydrocarbon conversion process comprising the steps of:
(a) providing a color correlation that correlates average coke content on the catalyst and/or the coke level distribution on the catalyst as a function of color information;
(b) determining color information for the catalyst sample, wherein the catalyst sample has an unknown coke content; and
(c) applying the color information to the color correlation to determine one or more values for the unknown coke content;
(d) correlating the coke content values determined in step (c) to one or more process variables of a hydrocarbon conversion process to control the same or a different one or more process variables to control and/or optimize the hydrocarbon conversion process.

42. The method of claim 41 wherein the hydrocarbon conversion process is an oxygenate-to-olefins process.
